(19) United States
(12) Patent Application Publication
(10) Pub. No.: US 2019/0062878 A1
(43) Pub. Date: Feb. 28, 2019

(54) ALUMINUM ALLOY SUBSTRATE FOR MAGNETIC RECORDING MEDIUM, SUBSTRATE FOR MAGNETIC RECORDING MEDIUM, MAGNETIC RECORDING MEDIUM, AND HARD DISK DRIVE

(71) Applicant: SHOWA DENKO K.K., Tokyo (JP)

(72) Inventors: Isao MURASE, Oyama-shi (JP); Kiminori SUGIMOTO, Osaka (JP); Yasuhiko NARA, Oyama-shi (JP); Yoshikazu KATO, Oyama-shi (JP)

(73) Assignee: SHOWA DENKO K.K., Tokyo (JP)

(21) Appl. No.: 16/105,062

(22) Filed: Aug. 20, 2018

(30) Foreign Application Priority Data
Aug. 28, 2017 (JP) 2017-163315
Aug. 28, 2017 (JP) 2017-163316
Aug. 28, 2017 (JP) 2017-163317

(51) Int. Cl. C22C 21/02; G11B 5/64; C23C 18/16

(52) U.S. Cl. CPC C22C 21/02; C23C 18/1689; C23C 18/1637; G11B 5/647

(57) ABSTRACT

An aluminum alloy substrate for a magnetic recording medium, the substrate including: Si in a range of 9.5 to 13.0% by mass or less and Cu in a range of 0.5 to 3.0% by mass or less, wherein a content of Fe is less than 0.01% by mass, the balance is Al, the substrate has a diameter in a range of 53 to 97 mm and a thickness in a range of 0.4 to 0.9 mm or less, and the substrate satisfies at least one of the following conditions (i) and (ii): (i) Sr is contained in the substrate in a range of 0.005% by mass or more and 0.1% by mass or less; and (ii) at least a part of the Si is present as Si particles, and an average particle diameter of particles having a longest diameter of 0.5 μm or more among the Si particles is 2 μm or less.

### BACKGROUND OF THE INVENTION

### Field of the Invention

The present invention relates to an aluminum alloy substrate for a magnetic recording medium, a substrate for a magnetic recording medium, a magnetic recording medium and a hard disk drive.

Priority is claimed on Japanese Patent Application No. 2017-163315, Japanese Patent Application No. 2017-163316, and Japanese Patent Application No. 2017-163317, filed Aug. 28, 2017, the contents of which are incorporated herein by reference.

### Description of the Related Art

In recent years, remarkable improvement has been made in the recording density in magnetic recording media used for hard disk drives. In particular, since the introduction of magneto resistive (MR) head and partial response maximum likelihood (PRML) technology, the rise in the areal recording density of the magnetic recording media has become even more intense.

In addition, due to development of the Internet network and expansion of utilization of big data in recent years, the amount of data accumulated in the data center has also been continued to increase. Further, due to the problem in terms of space of the data center, there is a necessity to increase the storage capacity per unit volume of the data center. That is, in order to increase the storage capacity per standardized hard disk drive, in addition to increasing the storage capacity per magnetic recording medium, it has been attempted to increase the number of magnetic recording media to be accommodated in the drive case.

Aluminum alloy substrates and glass substrates have been mainly used as substrates for magnetic recording media. Among them, the aluminum alloy substrates have higher toughness and are easier to produce, as compared with the glass substrates. Accordingly, they are used for a magnetic recording medium having a relatively large outer diameter. The thickness of an aluminum alloy substrate used for a magnetic recording medium of a 3.5-inch hard disk drive is usually 1.27 mm. For this reason, a maximum of five magnetic recording media can be accommodated inside the drive case.

In order to increase the number of magnetic recording media to be accommodated inside the drive case, attempts have been made to thin the substrates used for the magnetic recording media.

However, when the substrate is thinned, fluttering tends to occur in the aluminum alloy substrate, as compared with the glass substrate.

The term “fluttering” refers to fluttering of a magnetic recording medium which occurs when the magnetic recording medium is rotated at a high speed. When the level of fluttering increases, stable reading in the hard disk drive becomes difficult.

For example, in a glass substrate, it is known to use a material having high specific elasticity (specific Young's modulus) as a material of a substrate for a magnetic recording medium in order to suppress the fluttering (see, for example, Patent Document 1).

Further, attempts have been made to reduce the fluttering by filling helium gas into the drive case of a 3.5-inch hard disk drive, thereby thinning the aluminum alloy substrate and accommodating six or more magnetic recording media inside the drive case.

In general, a substrate for a magnetic recording medium is manufactured by the following steps. First, an aluminum alloy ingot is rolled to obtain an aluminum alloy sheet material having a thickness of about 2 mm or less. The obtained aluminum alloy sheet material is punched into a disk shape to a desired size. Then, chamfering of the inner and outer diameters and turning of the data surface are applied to the disk of the punched aluminum alloy sheet material. Thereafter, in order to reduce the surface roughness and waviness of the aluminum alloy sheet material after the turning process, grinding with a grindstone is performed to form an aluminum alloy substrate. Then, NiP plating is applied to the surface of the aluminum alloy substrate for the purpose of imparting surface hardness and suppressing surface defects. Next, polishing is applied to both surfaces (data surface) of the aluminum alloy substrate on which a NiP plating film has been formed.

Substrates for magnetic recording media are mass-produced products and high cost performance is required. For this reason, an aluminum alloy is required to have high machinability and a low price.

Patent Document 2 discloses an aluminum alloy containing 0.3 to 6% by mass of Mg, 0.3 to 10% by mass of Si, 0.05 to 1% by mass of Zn and 0.001 to 0.3% by mass of Sr, and the balance being Al and impurities.

In addition, Patent Document 3 discloses an aluminum alloy substrate for a magnetic disk containing 0.5% by mass or more and 24.0% by mass or less of Si and 0.01% by mass or more and 3.00% by mass or less of Fe, and the balance being Al and unavoidable impurities.

Further, Patent Document 4 discloses the following method for manufacturing an Al—Mg based alloy rolled sheet for a magnetic disk. In this method, firstly, continuous casting is carried out in which an Al—Mg based alloy containing 0.1 wt % or less of Zr is formed into a thin plate having a plate thickness of 4 to 10 mm, and the thus obtained cast metal plate is subjected to cold rolling with a high processing rate of 50% or more without carrying out a soaking treatment. Thereafter, annealing is performed at a temperature of 300 to 400° C. to produce a rolled sheet having an average crystal grain size of 15 μm or less in the surface layer portion. Here, the Al—Mg based alloy contains 2.0 to 6.0 wt % of Mg and 0.01 to 0.1 wt % of one or two of Ti and B, and further contains one or two of 0.03 to 0.3 wt % of Cr and 0.03 to 0.3 wt % of Mn.

In addition, in order to provide a substrate for a magnetic recording medium having a high Young's modulus and excellent machinability, Patent Document 5 has disclosed to contain Mg in the range of 0.2 to 6% by mass, Si in the range of 3 to 17% by mass, Zn in the range of 0.05 to 2% by mass and Sr in the range of 0.001 to 1% by mass in an alloy structure of an aluminum alloy substrate, and to set the average particle diameter of Si particles to 2 μm or less in the alloy structure of the aluminum alloy substrate.

### PRIOR ART DOCUMENTS

### Patent Documents

[Patent Document 1] Japanese Unexamined Patent Application, First Publication No. 2015-26414

[Patent Document 2] Japanese Unexamined Patent Application, First Publication No. 2009-24265

[Patent Document 3] International Patent Publication No. WO 2016/068293

[Patent Document 4] Japanese Unexamined Patent Application, First Publication No. Hei 6-145927

[Patent Document 5] Japanese Unexamined Patent Application, First Publication No. 2017-120680

### SUMMARY OF THE INVENTION

### Problems to be Solved by the Invention

In a substrate for a magnetic recording medium used as a base material of a magnetic recording medium for a hard disk drive, the following is desired. That is, it is desired that: the fluttering is suppressed, in other words, the range of displacement due to fluttering: non-repeatable run-out (NRRO) is small; and the plating characteristics are excellent, in other words, the NiP-based plating film is uniformly formed. As described in Patent Documents 2 to 5, in order to improve these properties, addition of various elements to an aluminum alloy substrate has been actively studied.

However, according to the investigation by the inventors of the present invention, with the compositions of the conventional aluminum alloys described in Patent Documents 2 to 5, it is difficult to improve the plating characteristics while suppressing the level of fluttering, for example, when the compositions are formed into a substrate having a thin shape so as to be capable of being accommodated in larger numbers than ever before in a drive case of a standardized hard disk drive, so that 6 or more substrates can be accommodated in a drive case of a hard disk drive having a size of 3.5 inches or the like. In addition, in some cases, the castability in casting an aluminum alloy ingot and the workability in machining a disk of an aluminum alloy sheet material are deteriorated, and therefore it is difficult to stably produce an aluminum alloy substrate from an industrial perspective.

The present invention has been made in view of the above circumstances, and has an object of providing: a substrate for a magnetic recording medium with improved plating characteristics while suppressing the level of fluttering even in a thin shape that can be accommodated in larger numbers than ever before in a drive case of a standardized hard disk drive; and an aluminum alloy substrate capable of being used for a magnetic recording medium which can be advantageously used as a base material of the substrate for a magnetic recording medium. The present invention also has an object of providing a magnetic recording medium having the above-mentioned substrate for a magnetic recording medium, and a hard disk drive including the same.

### Means for Solving the Problem

In order to solve the above problems, the inventors of the present invention conducted intensive research and found, as a result, that an aluminum alloy substrate containing Si and Cu in predetermined ranges has improved rigidity, and that an increase in the NRRO due to fluttering can be suppressed even when the substrate for a magnetic recording medium in which a NiP-based plating film is formed on the aluminum alloy substrate has a thin shape. However, it was revealed that the aluminum alloy substrate containing Si and Cu was likely to generate coarse Si particles, and therefore it is difficult to uniformly form a NiP-based plating film on the substrate.

As a result of further research, the inventors of the present invention have discovered that it is possible to suppress the formation of coarse Si particles and to uniformly form a NiP-based plating film on an aluminum alloy substrate by adding Sr in a predetermined range to the aluminum alloy substrate.

In addition, the inventors of the present invention have found that by setting the average particle diameter of particles having the longest diameter of 0.5 pun or more among the Si particles contained in the aluminum alloy substrate to 2 μm or less, the NiP-based plating film can be easily formed uniformly on the aluminum alloy substrate.

Further, the inventors of the present invention have found that the aluminum alloy having the above composition is likely to generate scratches during grinding when manufacturing an aluminum alloy substrate. As a result of further research, it was found that the generation of scratches during grinding can be suppressed by reducing the content of Fe in the aluminum alloy.

Further, as a result of investigation, it was confirmed that by forming a NiP-based plating film on an aluminum alloy substrate containing the respective elements of Si, Cu, Sr, and Fe in predetermined amounts, a substrate for a magnetic recording medium with improved plating characteristics could be obtained while suppressing the level of fluttering, and the substrate according to a first aspect of the present invention was completed.

In addition, as a result of investigation, it was confirmed that an aluminum alloy substrate containing the respective elements of Si, Cu and Fe in predetermined amounts and in which the average particle diameter of particles having the longest diameter of 0.5 μm or more, which are included in the Si particles contained in the alloy, is 2 μm or less, is capable of providing a substrate for a magnetic recording medium with improved plating characteristics while suppressing the level of fluttering, by forming a NiP-based plating film on the aluminum alloy substrate, thereby completing the substrate of a fifth aspect of the present invention.

Furthermore, according to the studies by the inventors of the present invention, in a magnetic recording medium which is rotated at an extremely high rotational speed of 5,000 rpm or more during normal use, it turned out that the NRRO due to fluttering fluctuated not only by the rigidity of the substrate for a magnetic recording medium but also by the density. Further, by paying attention to the Young's modulus which is one of the physical property values indicative of the rigidity of the material and examining the relationship between the Young's modulus E (unit: GPa), the density ρ (unit: g/cm³) and the NRRO, it was discovered that an increase in the NRRO can be suppressed when a ratio E/ρ between the Young's modulus E and the density ρ is equal to or greater than a predetermined value, thereby completing the substrate of a ninth aspect of the present invention.

That is, the present invention provides the following aspects in order to solve the above problems.

(1) An aluminum alloy substrate for a magnetic recording medium according to a first aspect of the present invention is characterized by including Si in a range of 9.5% by mass or more and 13.0% by mass or less, Cu in a range of 0.5% by mass or more and 3.0% by mass or less and Sr in a range of 0.005% by mass or more and 0.1% by mass or less, and in which a content of Fe is less than 0.01% by mass, the balance is Al, a diameter of the substrate is in a range of 53 mm or more and 97 mm or less and a thickness thereof is in a range of 0.4 mm or more and 0.9 mm or less.

(2) The aluminum alloy substrate for a magnetic recording medium according to the above (1) may further contain Zn in a range of 0.01% by mass or more and 0.4% by mass or less.

(3) The aluminum alloy substrate for a magnetic recording medium according to the above (1) or (2) may further contain at least one or more types of metal elements selected from the group consisting of Cr, Ti and Ni in a range of 0.005% by mass or more and 1.0% by mass or less in total.

(4) The aluminum alloy substrate for a magnetic recording medium according to any one of the above (1) to (3) may further contain Mn in a range of 0.05% by mass or more and 0.4% by mass or less.

(5) The aluminum alloy substrate for a magnetic recording medium according to any one of the above (1) to (4) may further contain Zr in a range of 0.03% by mass or more and 0.3% by mass or less.

(6) In the aluminum alloy substrate for a magnetic recording medium according to any one of the above (1) to (5), a content of Mg may be less than 0.05% by mass.

(7) In the aluminum alloy substrate for a magnetic recording medium according to any one of the above (1) to (6), a content of B may be less than 0.001% by mass.

(8) In the aluminum alloy substrate for a magnetic recording medium according to any one of the above (1) to (7), a content of P may be less than 0.001% by mass.

(9) In the aluminum alloy substrate for a magnetic recording medium according to any one of the above (1) to (8), it is also preferable that at least a part of the aforementioned Si is present as Si particles, and an average particle diameter of particles having a longest diameter of 0.5 μm or more among the aforementioned Si particles is 2 μm or less.

(10) A substrate for a magnetic recording medium according to a second aspect of the present invention is characterized by being a substrate for a magnetic recording medium including the aluminum alloy substrate according to any one of the above (1) to (8), and a NiP-based plating film formed on at least one surface of the aforementioned aluminum alloy substrate.

(11) A magnetic recording medium according to a third aspect of the present invention is characterized by including the substrate for a magnetic recording medium according to the above (9), and a magnetic layer provided on a surface of the aforementioned substrate for a magnetic recording medium on a side where the aforementioned NiP-based plating film is formed.

(12) A hard disk drive according to a fourth aspect of the present invention is characterized by being a hard disk drive including the magnetic recording medium according to the above (11).

(13) An aluminum alloy substrate for a magnetic recording medium according to a fifth aspect of the present invention is characterized by including Si in a range of 9.5% by mass or more and 13.0% by mass or less and Cu in a range of 0.5% by mass or more and 3.0% by mass or less, and in which a content of Fe is less than 0.01% by mass, the balance is Al, at least a part of the aforementioned Si is present as Si particles, and an average particle diameter of particles having a longest diameter of 0.5 μm or more among the aforementioned Si particles is 2 μm or less, a diameter of the substrate is in a range of 53 mm or more and 97 mm or less, and a thickness is in a range of 0.4 mm or more and 0.9 mm or less.

(14) The substrate of the above (13) preferably contains Sr in a range of 0.005% by mass or more and 0.1% by mass or less.

(15) A substrate for a magnetic recording medium according to a sixth aspect of the present invention is characterized by including the aluminum alloy substrate according to the above (13), and a NiP-based plating film formed on at least one surface of the aforementioned aluminum alloy substrate.

(16) A magnetic recording medium according to a seventh aspect of the present invention is characterized by being a magnetic recording medium including the substrate for a magnetic recording medium according to the above (15), and a magnetic layer provided on a surface of the aforementioned substrate for a magnetic recording medium on a side where the aforementioned NiP-based plating film is formed.

(17) A hard disk drive according to an eighth aspect of the present invention is characterized by being a hard disk drive including the magnetic recording medium according to the above (16).

(18) A substrate for a magnetic recording medium according to a ninth aspect of the present invention is a substrate for a magnetic recording medium including an aluminum alloy substrate and a NiP-based plating film formed on at least one surface of the aforementioned aluminum alloy substrate, and is characterized in that a ratio E/ρ of the Young's modulus E expressed in a unit of GPa to the density ρ expressed in a unit of g/cm³, of the aforementioned substrate, is 29 or more: and the aforementioned aluminum alloy substrate includes Si in a range of 9.5% by mass or more and 13.0% by mass or less and Cu in a range of 0.5% by mass or more and 3.0% by mass or less, and in which a content of Fe is less than 0.01% by mass, the balance is Al, a diameter of the substrate is in a range of 53 mm or more and 97 mm or less, and a thickness is in a range of 0.4 mm or more and 0.9 mm or less, and has at least one of characteristics (i) and (ii):

(i) Sr is contained in the aforementioned substrate in a range of 0.005% by mass or more and 0.1% by mass or less, and

(ii) at least a part of the aforementioned Si is present as Si particles, and an average particle diameter of particles having a longest diameter of 0.5 μm or more among the aforementioned Si particles is 2 μm or less.

(19) A magnetic recording medium according to a tenth aspect of the present invention is characterized by including the substrate for a magnetic recording medium according to the above (18), and a magnetic layer provided on a surface of the aforementioned substrate for a magnetic recording medium on a side where the aforementioned NiP-based plating film is formed.

(20) A hard disk drive according to an eleventh aspect of the present invention is characterized by including the magnetic recording medium according to the above (19).

### Effects of the Invention

According to the present invention, it is possible to provide a substrate for a magnetic recording medium with improved plating characteristics while suppressing the level of fluttering, even when having a thin shape that can be accommodated in larger numbers than ever before in a drive case of a standardized hard disk drive; and an aluminum alloy substrate for a magnetic recording medium which can be advantageously used as a base material of the aforementioned substrate for a magnetic recording medium. Further, according to the present invention, it is possible to provide a magnetic recording medium having the above-mentioned substrate for a magnetic recording medium and a hard disk drive including the magnetic recording medium.

### BRIEF DESCRIPTION OF THE DRAWINGS

FIG. 1 is a schematic cross-sectional view showing a preferable example of a substrate for a magnetic recording medium according to the present embodiment.

FIG. 2 is a perspective view showing a preferable example of a grinding machine that can be used in manufacturing a substrate for a magnetic recording medium according to the present embodiment.

FIG. 3 is a schematic cross-sectional view showing a preferable example of a magnetic recording medium according to the present embodiment.

FIG. 4 is a perspective view showing a preferable example of a hard disk drive according to the present embodiment.

### DETAILED DESCRIPTION OF THE INVENTION

Hereinafter, preferred examples of the aluminum alloy substrate for a magnetic recording medium, the substrate for a magnetic recording medium, the magnetic recording medium and the hard disk drive according to preferred embodiments of the present invention will be described in detail with reference to the drawings as appropriate. That is, the first to eleventh aspects of the present application preferably have the following features. In the drawings used in the following description, characteristic portions and components may be shown in an enlarged manner in some cases for the sake of simplicity in order to facilitate understanding of the characteristics of the present invention, and the dimensional ratio or the like of each constituent element may be different from that employed in reality. The present invention is not limited to the following examples, and can be appropriately changed without departing from the spirit or scope of the present invention. It is possible to change or add numbers, positions, sizes and numerical values.

### [Aluminum Alloy Substrate for Magnetic Recording Medium]

An aluminum alloy substrate for a magnetic recording medium according to the present embodiment contains Si in a range of 9.5% by mass or more and 13.0% by mass or less and Cu in a range of 0.5% by mass or more and 3.0% by mass or less.

The aluminum alloy substrate according to the first aspect of the present invention further contains Sr in a range of 0.005% by mass or more and 0.1% by mass or less.

In the aluminum alloy substrate of the fifth aspect, at least a part of Si exists as Si particles. Further, among the Si particles, an average particle diameter of the particles having the longest diameter of 0.5 μm or more is 2 μm or less.

The aluminum alloy substrate for a magnetic recording medium of the present embodiment may further contain Zn in a range of 0.01% by mass or more and 0.4% by mass or less, and at least one or more types of metal elements selected from the group consisting of Cr, Ti and Ni in a range of 0.005% by mass or more and 1.0% by mass or less in total, Mn in a range of 0.05% by mass or more and 0.4% by mass or less, and Zr in a range of 0.03% by mass or more and 0.3% by mass or less, respectively. Further, the substrate of the fifth aspect may contain Sr in a range of 0.005% by mass or more and 0.1% by mass or less. The substrate of the first aspect may have the features of the substrate of the fifth aspect, and the substrate of the fifth aspect may have the features of the substrate of the first aspect.

The aluminum alloy substrate for a magnetic recording medium of the present embodiment can be composed of the above metal elements, unavoidable impurities, and Al as the balance. The unavoidable impurities are impurities that are mixed in an unavoidable manner from raw materials and manufacturing processes. In the present embodiment, the content of Fe as an unavoidable impurity is less than 0.01% by mass. Further, it is preferable that the content of Mg is less than 0.05% by mass, the content of B is less than 0.001% by mass, and the content of P is less than 0.001% by mass.

In addition, in the aluminum alloy substrate for a magnetic recording medium according to the first aspect, it is also preferable that the average particle diameter of Si particles having the longest diameter of 0.5 μm or more is 2 μm or less.

Furthermore, it is preferable that the aluminum alloy substrate for a magnetic recording medium of the present embodiment is in the shape of a disk having an opening at the center. Although the size of the aluminum alloy substrate can be arbitrarily selected, in the present example, the diameter is in the range of 53 mm or more and 97 mm or less, and the thickness is in the range of 0.4 mm or more and 0.9 mm or less.

Hereinafter, each element and the average particle diameter of Si particles contained in the aluminum alloy substrate for a magnetic recording medium of the present embodiment, and the size (diameter, thickness) will be described.

### (Si)

A small amount of Si forms a solid solution in Al. Therefore, it is mainly dispersed in the aluminum alloy structure as Si particles of a simple substance of Si. The rigidity improves in the aluminum alloy substrate in which Si particles are dispersed. Further, at the time of processing of the substrate by a cutting tool, chips are easily divided, that is, chip dividing properties are improved by pulverization of the Si particles and/or peeling at the interface between the Si particles and the Al parent phase. Therefore, the workability in manufacturing the aluminum alloy substrate is improved.

If the Si content contained in the aluminum alloy is less than 9.5% by mass, there is a possibility that the above effects become difficult to obtain. On the other hand, when the Si content exceeds 13.0% by mass, the average particle diameter of the Si particles dispersed in the aluminum alloy structure increases and, although the chip dividing properties of the aluminum alloy improves, the wear of the cutting tool observed after processing becomes remarkably large and the productivity of the aluminum alloy substrate may decrease. In addition, it is difficult to form a NiP-based plating film on the Si particles. For this reason, it is difficult to form a uniform NiP-based plating film on an aluminum alloy substrate in which Si particles having an excessively large average particle diameter are dispersed, and therefore there is a possibility that the substrate for a magnetic recording medium using this aluminum alloy substrate has poor plating characteristics.

Therefore, in the present embodiment, the content of Si is set within the range of 9.5% by mass or more and 13.0% by mass or less. The Si content is preferably in the range of 10.0% by mass or more and 12.0% by mass or less. The lower limit value may be 10.5% by mass or more. The upper limit value may be 11.5% by mass or less.

### (Cu)

Cu has an effect of improving the rigidity of the aluminum alloy substrate by forming a solid solution of Cu in the aluminum alloy structure. In addition, Cu forms an Al₂Cu phase in the aluminum alloy structure, thereby having the effect of further improving the rigidity of the aluminum alloy substrate.

If the content of Cu is less than 0.5% by mass, there is a possibility that the above effects cannot be obtained. On the other hand, if the content of Cu exceeds 3.0% by mass, the density of the aluminum alloy substrate becomes high, and the substrate for a magnetic recording medium using the aluminum alloy substrate may deteriorate in view of the problem of fluttering.

Therefore, in the present embodiment, the content of Cu is set within the range of 0.5% by mass or more and 3.0% by mass or less. The Cu content is preferably in the range of 1.0% by mass or more and 2.8% by mass or less. The lower limit value may be 1.5% by mass or more. The upper limit value may be 2.3% by mass or less.

### (Sr)

By coexisting with Si, Sr has the effect of making eutectic Si crystals and primary Si crystals spherical at the time of solidification, and refining Si particles. By the effect of refining the Si particles, the chip dividing properties of the aluminum alloy is indirectly improved, so that the workability of the aluminum alloy is improved, and wear and damage of the cutting tool at the time of processing can be suppressed. Further, it has the effect of uniformly and finely dispersing the Si particles in the steps of casting, extrusion, drawing and the like, and further improving the machinability of the alloy. In addition, it has the effect of making the structure of the NiP-based plating film formed on the surface of the aluminum alloy substrate uniform, and also making the film quality of the NiP-based plating film uniform.

If the content of Sr is less than 0.005% by mass, there is a possibility that the above effects cannot be obtained. That is, the Si particles do not become spherical, and an acute angle portion is generated, which may cause wear and damage on the cutting tool at the time of processing. On the other hand, if the content of Sr exceeds 0.1% by mass, the effect of improving the machinability of the alloy is saturated, which reduces the importance of further addition. In addition, when the content of Sr is increased, SrAl₄ is formed, and this SrAl₄ acts as a nucleus to make primary crystals of Si coarse, and the average particle diameter of Si particles becomes large at times.

Therefore, in the first aspect, the content of Sr is set in the range of 0.005% by mass or more and 0.1% by mass or less. The content of Sr is preferably in the range of 0.01% by mass or more and 0.05% by mass or less. The lower limit value may be 0.008% by mass or more. The upper limit value may be 0.04% by mass or less. The substrate of the fifth aspect can also preferably have this feature.

### (Zn)

When contained, Zn forms a solid solution in the aluminum alloy structure and bonds with other additives and disperses as precipitates in the aluminum alloy structure. This not only improves the mechanical strength of the aluminum alloy but also has an effect of improving the workability (machinability) at the time of manufacturing the aluminum alloy substrate, due to the synergistic effect with other solid solution-type elements, as well as promoting the formation of the NiP-based plating film.

When the content of Zn is less than 0.01% by mass, there is a possibility that the above effects cannot be obtained. On the other hand, if the content of Zn exceeds 0.4% by mass, the corrosion resistance of the alloy may decrease.

Therefore, in the present embodiment, the content of Zn is preferably set in the range of 0.01% by mass or more and 0.4% by mass or less.

### (Cr, Ti and Ni)

Cr can improve the strength since it refines the rolled structure, Ti is effective in preventing leakage during casting since it can refine the cast structure, and Ni has the effect of improving the Young's modulus. By these effects, when at least one of Cr, Ti and Ni is added, the castability (flowability of the molten metal of the raw material mixture, shrinkage characteristics, hot cracking resistance) is improved at the time of casting the aluminum alloy ingot, and at the same time, the mechanical strength is increased, and the workability (machinability) at the time of manufacturing the aluminum alloy substrate is improved. When these are used, one of Cr, Ti and Ni may be used alone, or two or more of these may be used in combination.

If the total content of Cr, Ti and Ni is less than 0.005% by mass, there is a possibility that the above effects cannot be obtained. On the other hand, when the total content of Cr, Ti and Ni exceeds 1.0% by mass, the above effects are saturated, which reduces the importance of further addition.

Therefore, in the present embodiment, the total content of Cr, Ti and Ni is preferably set in the range of 0.005% by mass or more and 1.0% by mass or less.

### (Mn)

When included, Mn has the effects of being finely precipitated in the aluminum alloy structure, enhancing the mechanical strength of the alloy and improving the workability in manufacturing the aluminum alloy substrate.

When the content of Mn is less than 0.05% by mass, there is a possibility that the above effects cannot be obtained. On the other hand, when the content of Mn exceeds 0.4% by mass, the above effects are saturated, which reduces the importance of further addition.

Therefore, in the present embodiment, the content of Mn is preferably set in the range of 0.05% by mass or more and 0.4% by mass or less.

### (Zr)

When included, Zr has the effect of refining Si particles, similar to Sr. Further, by forming a fine Si₂Zr compound in the aluminum alloy structure, there is an effect of improving the rigidity of the aluminum alloy substrate.

When the content of Zr is less than 0.03% by mass, there is a possibility that the above effects cannot be obtained. On the other hand, when the content of Zr exceeds 0.3% by mass, the above effects are saturated, which reduces the importance of further addition.

Therefore, in the present embodiment, the content of Zr is preferably set in the range of 0.03% by mass or more and 0.3% by mass or less.

### (Fe)

Fe is an impurity that is mixed from raw materials in an unavoidable manner. If the Fe content is 0.01% by mass or more, coarse crystallized products of an Al—Si—Fe compound may be formed in the aluminum alloy structure. When coarse crystallized products of an Al—Si—Fe compound are produced, a large number of scratches may be generated during grinding when manufacturing an aluminum alloy substrate, and many portions that cannot be used for a magnetic recording medium are generated, which may lower the workability. In addition, in the substrate for a magnetic recording medium using the aluminum alloy substrate in which the coarse crystallized products of an Al—Si—Fe compound are formed, the Al—Si—Fe compound is dropped off at the time of processing and dents are formed, which may lower the plating characteristics.

Therefore, in the present embodiment, the content of Fe is set to less than 0.01% by mass.

### (Mg)

Mg is an impurity that is mainly mixed from raw materials in an unavoidable manner. If the content of Mg is 0.05% by mass or more, castability at the time of casting the aluminum alloy ingot may be deteriorated.

Therefore, in the present embodiment, the content of Mg is preferably set to less than 0.05% by mass.

### (B)

B is an impurity that is mainly mixed from raw materials in an unavoidable manner. When the content of B is 0.001% by mass or more, there is a possibility that the effect of miniaturization of Si particles by the addition of Sr is reduced.

Therefore, in the present embodiment, the content of B is preferably set to less than 0.001% by mass.

### (P)

P is an impurity that is mainly mixed from raw materials in an unavoidable manner. When the P content is 0.001% by mass or more, coarse Si particles having AlP particles as nuclei are formed, and there is a possibility that the workability and plating characteristics at the time of manufacturing the aluminum alloy substrate are deteriorated.

Therefore, in the present embodiment, the content of P is preferably set to less than 0.001% by mass.

### (Average Particle Diameter of Si Particles)

As described above, in the substrate for a magnetic recording medium using an aluminum alloy substrate in which Si particles having an excessively large average particle diameter is dispersed, there is a possibility that the plating characteristics may be deteriorated.

According to the investigation by the inventors of the present invention, it was found that the substrate for a magnetic recording medium using an aluminum alloy substrate in which an average particle diameter of Si particles having a longest diameter of 0.5 μm or more is 2 μm or more has a tendency to significantly lower the plating characteristics.

Therefore, in the present embodiment, the average particle diameter of the Si particles having the longest diameter of 0.5 μm or more is preferably set to 2 μm or less.

It should be noted that the average particle diameter of the Si particles is a value obtained from the cross-sectional image of the aluminum alloy substrate by an image analysis method. More specifically, the average particle diameter of Si particles is a value obtained by the following method. First, a sectional image of an aluminum alloy substrate is photographed using an electron microscope such as FE-SEM. Subsequently, Si particles having a longest diameter of 0.5 μm or more are extracted from the obtained cross-sectional image by an image analysis method, and the longest diameters of the extracted Si particles are measured. Then, by calculating the average value of the measured longest diameters, the intended value is obtained.

### (Size: Diameter, Thickness)

The aluminum alloy substrate for a magnetic recording medium of the present embodiment is preferably used mainly for a magnetic recording medium of a hard disk drive. It is necessary that the magnetic recording medium can be accommodated in a standardized hard disk drive, that is, a 2.5-inch hard disk drive, a 3.5-inch hard disk drive or the like. For example, in a 2.5-inch hard disk drive, a magnetic recording medium with a maximum diameter of about 67 mm is used, and in a 3.5-inch hard disk drive, a magnetic recording medium with a maximum diameter of about 97 mm is used.

Therefore, in the present embodiment, the diameter of the aluminum alloy substrate is set in the range of 53 mm or more and 97 mm or less.

Further, in the hard disk drive, in order to increase the recording capacity, it is effective to increase the number of magnetic recording media accommodated in a case. For example, in a normal 3.5-inch hard disk drive, up to five magnetic recording media having a thickness of 1.27 mm are accommodated. However, it becomes possible to increase the recording capacity if six or more magnetic recording media can be accommodated.

Therefore, in the present embodiment, the thickness of the aluminum alloy substrate is set in the range of 0.4 mm or more and 0.9 mm or less.

### [Method for Producing Aluminum Alloy Substrate for Magnetic Recording Medium]

The aluminum alloy substrate for a magnetic recording medium of the present embodiment can be produced by a method including, for example, a casting step of preparing an aluminum alloy ingot containing the above elements, a rolling step of rolling the aluminum alloy ingot into a plate shape to obtain an aluminum alloy sheet material, and a processing step of molding the aluminum alloy sheet material into an aluminum alloy substrate for a magnetic recording medium.

### (Casting Step)

In the casting step, a mixture of raw materials containing the above elements is cast to produce an aluminum alloy ingot.

A method for casting the raw material mixture can be arbitrarily selected, and for example, a direct chill casting method (DC casting method) can be used. The direct chill casting method is a method in which molten metal of a raw material mixture is poured into a mold and then the mold is brought into direct contact with cooling water to cast an aluminum alloy ingot.

It is preferable that the obtained aluminum alloy ingot is subjected to a homogenization treatment. The homogenization treatment is carried out, for example, by heating an aluminum alloy ingot at a temperature of 300° C. or more and 600° C. or less, within a range of 1 hour or more to 5 hours or less.

### (Rolling Step)

In the rolling step, the aluminum alloy ingot obtained in the above casting step is rolled into a plate shape to obtain an aluminum alloy sheet material. The rolling method is not particularly limited, and a hot rolling method and a cold rolling method can be used. There are no particular limitations on the rolling conditions, and it is possible to adopt normal conditions that are employed when rolling an aluminum alloy ingot.

### (Processing Step)

In the processing step, preferably, the aluminum alloy sheet material obtained in the above rolling step is firstly punched into a disk shape to obtain an aluminum alloy disk. Subsequently, the aluminum alloy disk is heated, and annealed, at a temperature of, for example, 300° C. or higher and 500° C. or lower within a range of 0.5 hour or more and 5 hours or less. By performing annealing, it is possible to alleviate the strain inherent in the aluminum alloy disk substrate and to adjust the rigidity of the obtained aluminum alloy substrate within an appropriate range. Next, the surface and the end face of the annealed aluminum alloy disk are cut using a cutting tool or the like. As the cutting tool, for example, a diamond bit can be used. It should be noted that the annealing may be performed after the cutting process.

### [Substrate for Magnetic Recording Medium]

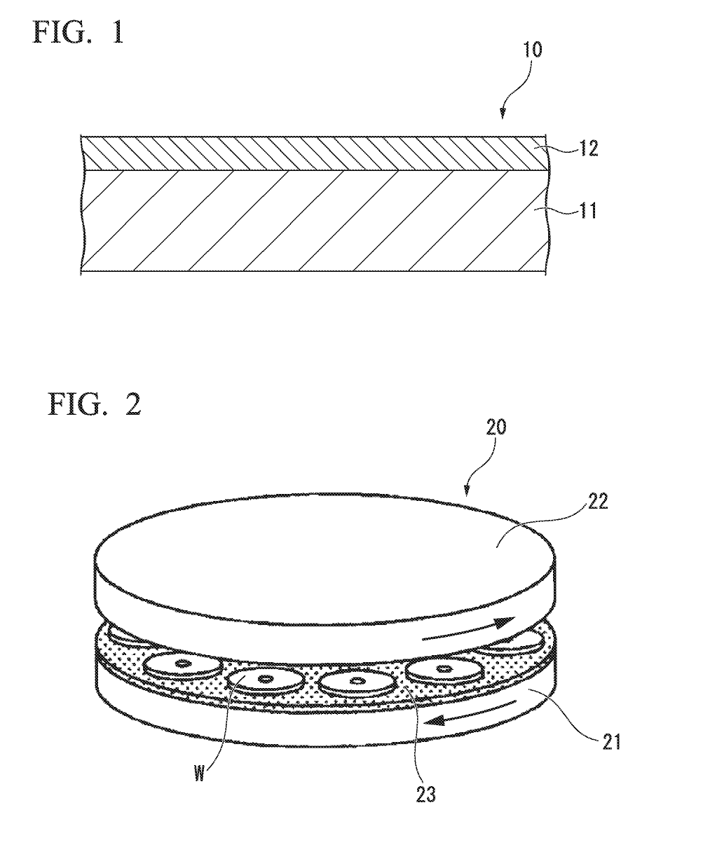

FIG. 1 is a cross-sectional view showing an example of a substrate for a magnetic recording medium according to the present embodiment.

As shown in FIG. 1, a substrate for a magnetic recording medium (magnetic recording medium substrate) 10 has an aluminum alloy substrate 11 and a NiP-based plating film 12 formed on at least one surface of the aluminum alloy substrate 11. In the magnetic recording medium substrate 10 of the present embodiment, it is preferable that the ratio E/ρ of the Young's modulus E expressed in a unit of GPa to the density ρ expressed in a unit of g/cm³ is 29 or more.

### (Aluminum Alloy Substrate)

As the aluminum alloy substrate 11, the above-described aluminum alloy substrate of the present embodiment is used.

### (NiP-Based Plating Film)

The NiP-based plating film 12 has the effect of improving the rigidity (Young's modulus) of the magnetic recording medium substrate 10.

The NiP-based plating film 12 may contain elements other than Ni and P. It is preferable that the NiP-based plating film 12 is formed of a NiP alloy containing Ni and P, or a NiWP alloy containing Ni, W, and P. It is preferable that the NiP alloy contains P in the range of 10% by mass or more and 15% by mass or less, and the balance being Ni and unavoidable impurities. It is preferable that the NiWP alloy contains W in the range of 15% by mass or more and 22% by mass or less, P in the range of 3% by mass or more and 10% by mass or less, and the balance being Ni and unavoidable impurities. By forming the NiP-based plating film 12 with the NiP alloy or NiWP alloy having the above composition, it is possible to reliably improve the rigidity of the magnetic recording medium substrate 10.

Although the thickness of the NiP-based plating film 12 can be arbitrarily selected, it is preferably 7 μm or more, and particularly preferably 9 μm or more. By setting the thickness of the NiP-based plating film 12 to this thickness, it is possible to reliably improve the rigidity of the magnetic recording medium substrate 10.

Further, the thickness of the NiP-based plating film 12 is preferably 20 μm or less, and particularly preferably 17 μm or less. By setting the thickness of the NiP based plating film 12 to this thickness, it is possible to achieve both flatness and light weight of the magnetic recording medium substrate 10.

(Ratio E/ρ of Young's modulus E to density ρ)

It is thought that increasing the rigidity of the substrate for a magnetic recording medium in order to suppress the fluttering characteristic of the substrate for a magnetic recording medium and suppress the increase in the displacement range (NRRO) due to fluttering is one of effective methods. On the other hand, according to the studies of the inventors of the present invention, it turned out that in a magnetic recording medium which is rotated at an extremely high rotational speed of 5,000 rpm or more during normal use, the NRRO value, that is, the fluttering characteristics, fluctuates, depending also on the density of the substrate for a magnetic recording medium. Further, by focusing on the Young's modulus which is one of the physical property values indicating the rigidity of the material, the relationship between the Young's modulus E (unit: GPa) and the density ρ (unit: g/cm³) of the substrate for a magnetic recording medium and the NRRO, that is, the fluttering characteristics, was examined. As a result, it was found that when the ratio E/ρ of the Young's modulus E to the density ρ is 29 or more, the increase in NRRO can be suppressed, that is, the fluttering can be suppressed, in other words, the fluttering can be reduced.

Therefore, in the present embodiment, the ratio E/ρ of the Young's modulus E to the density ρ is set to 29 or more. The ratio E/ρ is preferably 32 or less. The ratio E/ρ is also preferably 29.0 or more, and more preferably 29.2 or more. The ratio E/ρ is also preferably 32.0 or less, and more preferably 31.5 or less, or 30.5 or less.

In the substrate for a magnetic recording medium of the present embodiment, it is preferable that the ratio E/ρ is 29 or more by setting the Young's modulus E in the range of 79 GPa or more and 87 GPa or less, and the density ρ in the range of 2.6 g/cm³ or more and 3.0 g/cm³ or less.

### [Manufacturing Method of Substrate for Magnetic Recording Medium]

The substrate for a magnetic recording medium according to the present embodiment can be produced favorably by, for example, a method including: a plating step of forming a NiP-based plating film on the aluminum alloy substrate of the present embodiment by a plating method; and a polishing processing step of subjecting the surface of the aluminum alloy substrate with a NiP-based plating film to a polishing processing.

### (Plating Step)

In the plating step, it is preferable to use an electroless plating method as a method for forming a NiP-based plating film on the aluminum alloy substrate. The plating film made of a NiP alloy can be formed by using a conventionally used method. For the plating film made of a NiWP alloy, a plating solution obtained by adding a tungsten salt to the plating solution for the NiP alloy can be used. As the tungsten salt, for example, sodium tungstate, potassium tungstate, ammonium tungstate or the like can be used.

The thickness of the NiP-based plating film can be adjusted by the immersion time in the plating solution and the temperature of the plating solution. Plating conditions are not particularly limited, but it is preferable to set the pH of the plating solution to 5.0 to 8.6, the temperature of the plating solution to 70 to 100° C., preferably 85 to 95° C., and the immersion time in the plating solution to 90 to 150 minutes.

The obtained aluminum alloy substrate with the NiP-based plating film is preferably subjected to a heat treatment. This makes it possible to further increase the hardness of the NiP-based plating film and further increase the Young's modulus of the substrate for a magnetic recording medium. The temperature of the heat treatment is preferably set to 300° C. or higher.

### (Polishing Step)

In the polishing step, the surface of the aluminum alloy substrate with the NiP-based plating film obtained in the plating step is preferably polished. From the viewpoint of compatibility between improvement in surface quality such as smoothness and less scratches and improvement in productivity, the polishing step preferably employs a multi-stage polishing system having two or more polishing processes using a plurality of independent grinding machines. For example, it is also preferable to carry out a rough polishing step of polishing an aluminum alloy substrate while supplying a polishing liquid containing alumina abrasive grains by using a first grinding machine; and after washing the polished aluminum alloy substrate, a finish polishing step of polishing while supplying a polishing liquid containing colloidal silica abrasive grains using a second grinding machine.

FIG. 2 is a perspective view showing an example of a grinding machine that can be used in the polishing step.

As shown in FIG. 2, the first and second grinding machines 20 are provided with a pair of upper and lower surface plates 21 and 22. While sandwiching a plurality of substrates W between the surface plates 21 and 22 which rotate in mutually opposite directions, both surfaces of these substrates W are polished by polishing pads 23 provided on the surface plates 21 and 22.

### [Magnetic Recording Medium]

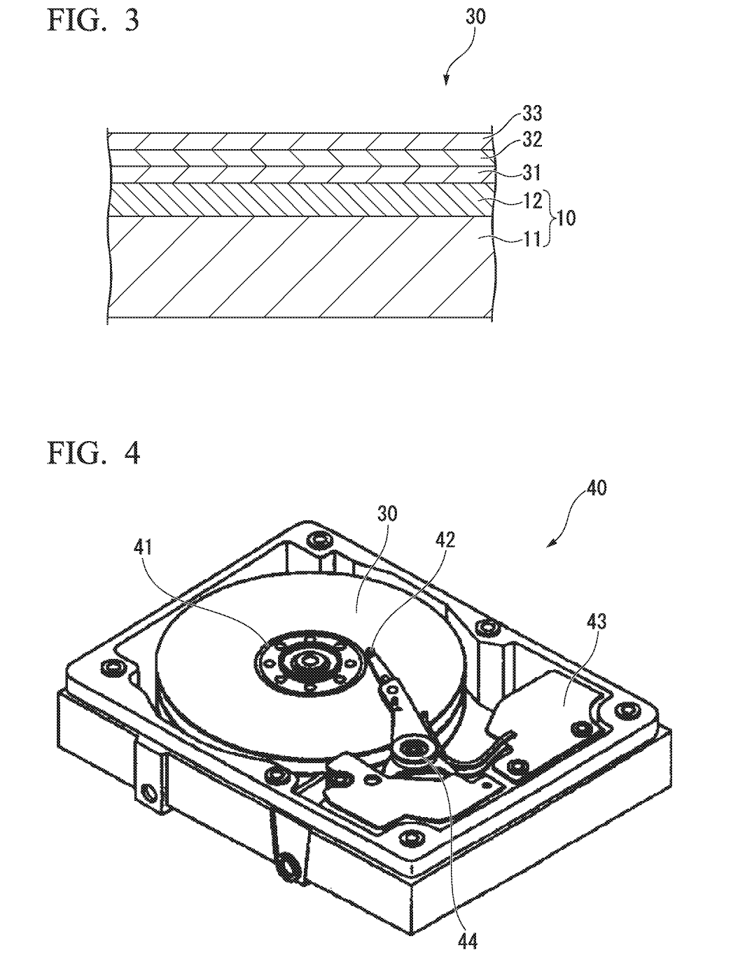

FIG. 3 is a schematic cross-sectional view showing an example of a magnetic recording medium according to the present embodiment.

As shown in FIG. 3, a magnetic recording medium 30 includes the above-mentioned magnetic recording medium substrate 10 and a magnetic layer 31 provided on the surface of the NiP-based plating film 12 of the magnetic recording medium substrate 10.

On the surface of the magnetic layer 31, a protective layer 32 and a lubricant layer 33 are further laminated in this order.

The magnetic layer 31 is composed of a magnetic film whose easy axis of magnetization is oriented perpendicular to the substrate surface. The magnetic layer 31 contains Co and Pt and may contain an oxide or Cr, B, Cu, Ta, Zr or the like in order to further improve the SNR characteristics. The oxide contained in the magnetic layer 31 can be arbitrarily selected, but SiO₂, SiO, Cr₂O₃, CoO, Ta₂O₃, TiO₂ and the like can be mentioned. The magnetic layer 31 may be composed of one layer or a plurality of layers made of materials having different compositions.

The thickness of the magnetic layer 31 is preferably set to, for example, 5 to 25 nm.

The protective layer 32 is a layer for protecting the magnetic layer 31. As the material of the protective layer 32, for example, carbon nitride can be used. The protective layer 32 may be composed of one layer or a plurality of layers.

The film thickness of the protective layer 32 is preferably in the range of 1 nm to 10 nm.

The lubricant layer 33 is a layer that prevents the contamination of the magnetic recording medium 30 and reduces the frictional force of a magnetic head of a magnetic recording/reproducing apparatus sliding on the magnetic recording medium 30, thereby improving the durability of the magnetic recording medium 30. As a material of the lubricant layer 33, for example, a perfluoropolyether-based lubricant or an aliphatic hydrocarbon-based lubricant can be used.

The film thickness of the lubricant layer 33 is preferably in the range of 0.5 nm to 2 nm.

A layer structure of the magnetic recording medium 30 in the present embodiment is not particularly limited, and a known laminated structure can be applied. For example, in the magnetic recording medium 30, a cohesive layer (not shown), a soft magnetic underlayer (not shown), a seed layer (not shown), and an orientation control layer (not shown) may be laminated in this order between the magnetic recording medium substrate 10 and the magnetic layer 31.

### [Hard Disk Drive]

FIG. 4 is a perspective view showing an example of a hard disk drive according to the present embodiment.

As shown in FIG. 4, a hard disk drive 40 includes the above-mentioned magnetic recording medium 30, a medium driving section 41 for driving the magnetic recording medium 30 in the recording direction, a magnetic head 42 including a recording section and a reproducing section, a head moving section 43 for relatively moving the magnetic head 42 with respect to the magnetic recording medium 30, and a recording/reproducing signal processing unit 44 for processing recording/reproducing signals from the magnetic head 42.

The magnetic recording medium substrate 10 can be made thin because the fluttering is reduced. Therefore, it is possible to provide the hard disk drive 40 with high recording capacity by increasing the number of the magnetic recording media 30 accommodated in the drive case of a standardized hard disk drive.

In addition, the magnetic recording medium substrate 10 has high machinability and can be manufactured at low cost. Therefore, it is possible to reduce the cost per unit bit of a hard disk drive having a high recording capacity.

Further, the fluttering in the atmosphere of the magnetic recording medium substrate 10 is reduced. Therefore, there is no need to seal a low molecular weight gas such as helium inside the hard disk drive case, and the manufacturing cost of the hard disk drive 40 having a high recording capacity can be reduced.

In addition, the hard disk drive 40 is particularly preferably used for a 3.5-inch hard disk drive having a high recording capacity.

Since the aluminum alloy substrate for a magnetic recording medium of the present embodiment according to the first aspect having the above-described configuration contains Si, Cu, Sr, and Fe in the above-mentioned amounts, it has high rigidity, and since the content of coarse Si particles is small, it is easy to form a uniform NiP-based plating film.

Further, the aluminum alloy containing Si, Cu, Sr, and Fe in the above-mentioned amounts is excellent in castability (flowability of the molten metal of the raw material mixture, shrinkage characteristics, hot cracking resistance) and workability (machinability). Therefore, the aluminum alloy substrate for a magnetic recording medium of the present embodiment can be stably manufactured from an industrial perspective.

Further, since the aluminum alloy substrate for a magnetic recording medium of the present embodiment according to the fifth aspect has the above-described configuration which contains Si and Cu in the above-mentioned amounts, it has high rigidity, and since the average particle diameter of Si particles having a longest diameter of 0.5 μm or more is set to 2 μm or less and the content of coarse Si particles is small, it is easy to form a uniform NiP-based plating film.

In addition, since the substrate for a magnetic recording medium according to the ninth aspect has the above-described aluminum alloy substrate for a magnetic recording medium and the NiP-based plating film, even if it has a thin shape having a diameter in the range of 53 mm or more and 97 mm or less and a thickness in the range of 0.4 mm or more and 0.9 mm or less, the plating characteristics can be improved while suppressing the level of fluttering.

Further, since the substrate for a magnetic recording medium of the ninth aspect has the above-described aluminum alloy substrate and the NiP-based plating film, and the ratio E/ρ of the Young's modulus E to the density ρ is set to be 29 or more, even if it has a thin shape having a diameter in the range of 53 mm or more and 97 mm or less and a thickness in the range of 0.4 mm or more and 0.9 mm or less, the plating characteristics can be further improved while suppressing the level of fluttering.

In addition, in the present invention, by including Zn within the above range in the aluminum alloy, the workability can be further improved, and the fluttering of the substrate for a magnetic recording medium can be further suppressed.

Moreover, the castability and workability can be further improved by including Cr, Ti, and Ni in the aluminum alloy within the above ranges.

Further, by including Mn within the above-mentioned range in the aluminum alloy, workability of the aluminum alloy can be further improved.

In addition, by including Zr within the above range in the aluminum alloy, the plating characteristics of the substrate for a magnetic recording medium can be further improved, and the fluttering can be further suppressed.

Further, by setting the content of Mg in the aluminum alloy to the above-mentioned amount, the castability can be further improved.

In addition, by setting the content of B in the aluminum alloy to the above-mentioned amount, the effect of miniaturization of Si particles by the addition of Sr can be further improved.

Further, by setting the content of P in the aluminum alloy to the above-mentioned amount, the workability can be further improved, and the plating characteristics of the substrate for a magnetic recording medium can be further improved.

In addition, the magnetic recording medium of the present embodiment includes a magnetic layer on the surface of the above-mentioned substrate for a magnetic recording medium. Therefore, it can be made into a thin shape that can be accommodated in larger numbers than ever before in a drive case of a standardized hard disk drive.

Further, since the hard disk drive of the present embodiment includes the magnetic recording medium described above, it is possible to accommodate more magnetic recording media in the drive case than ever before, thereby increasing the recording capacity.

### EXAMPLES

### Examples 1 to 24, Comparative Examples 1 to 7

Hereinafter, the effects of the present invention will be made clear by a series of examples. It should be noted that the present invention is not limited to the following examples, and can be carried out with appropriate modifications within the scope that does not change the spirit and gist thereof.

### [Production of Aluminum Alloy Substrate]

A pure Al block as a raw material of Al, simple substances or alloy blocks with Al as a raw material of Si, Cu, Sr, Zn, Cr, Ti, Ni, Mn, Zr, Fe, Mg and B, and a mixture block with Si as a raw material of P were prepared. It should be noted that for each raw material of Al, Si, Cu, Sr, Zn, Cr, Ti, Ni, Mn and Zr, those in which the content of Fe was less than 0.01% by mass, the content of Mg was less than 0.05% by mass, the content of B was less than 0.001% by mass, and the content of P was less than 0.001% by mass were prepared.

The prepared raw materials of the respective elements were weighed so that the compositions after casting had the compositions shown in Table 1. These were melted at 820° C. in the atmosphere to produce an aluminum alloy ingot by using a direct chill casting method (DC casting method). It should be noted that the casting temperature was 700° C. and the casting speed was 40 to 60 mm/min. Next, the obtained aluminum alloy ingot was held at 460° C. for 2 hours and subjected to a homogenization treatment. Thereafter, the resultant was rolled to obtain a sheet material having a thickness of 1.2 mm. The obtained aluminum alloy sheet material was punched into a disk shape having an opening at the center and a diameter of 97 mm, and annealed at 380° C. for 1 hour. Thereafter, the surface and the end face of the aluminum alloy disk were cut with a diamond bit to obtain an aluminum alloy substrate having a diameter of 96 mm and a thickness of 0.8 mm.

### [Production of Substrate for Magnetic Recording Medium]

The aluminum alloy substrate was immersed in a NiP-based plating solution, and a Ni₈₈P₁₂ (P content: 12% by mass, balance: Ni) film was formed as NiP-based plating film on the surface of the aluminum alloy substrate by using an electroless plating method.

As the NiP-based plating solution, a solution containing nickel sulfate (nickel source) and sodium hypophosphite (phosphorus source) was used, which was appropriately added with lead acetate, sodium citrate and sodium borate and adjusted for the amounts of the components so as to obtain a NiP-based plating film of the above composition. The NiP-based plating solution at the time of forming the NiP-based plating film was adjusted to a pH of 6 and a liquid temperature of 90° C. The immersion time of the aluminum alloy substrate into the NiP-based plating solution was set to 2 hours.

Subsequently, the aluminum alloy substrate on which the NiP-based plating film was formed was heated at 300° C. for 3 minutes to obtain an aluminum alloy substrate with a NiP-based plating film having a thickness of 10 μm.

Next, the surface of the aluminum alloy substrate with the NiP-based plating film was polished using a three-stage lapping machine provided with a pair of upper and lower surface plates as a grinding machine to prepare a substrate for a magnetic recording medium. At this time, a suede type pad (manufactured by Filwel Co., Ltd.) was used as a polishing pad. Further, for the first stage polishing, the second stage polishing and the third stage polishing performed by the lapping machine, alumina abrasive grains with D50 of 0.5 μm, colloidal silica abrasive grains with D50 of 30 nm and colloidal silica abrasive grains with D50 of 10 nm were used, respectively. In addition, the polishing time was set to 5 minutes in each stage.

### [Evaluation]

The following properties were evaluated.

### (Composition of Aluminum Alloy Substrate)

With respect to the obtained aluminum substrate, the composition was confirmed by wet analysis for Sr and by spectrochemical analysis (Quantolet analysis) for other elements. As a result, it was confirmed that the content of each metal element of the aluminum substrate was the same as the content shown in Table 1.

### (Castability)

Regarding the castability, the shape of the aluminum alloy ingot before rolling and the shape of the rolled aluminum alloy sheet material were visually evaluated. A case where the shape of the aluminum alloy ingot and that of the aluminum alloy sheet material were free of abnormalities was evaluated as A (excellent). A case where there was no problem in practical use although fine cracks or fractures were observed at the end portion of the aluminum alloy sheet material was evaluated as B (good). A case where there was no problem in practical use although distortions were observed at the end portion of the aluminum alloy sheet material was evaluated as C (acceptable). In this way, the evaluation was made. The results are shown in Table 2 below.

### (Workability)

The workability at the time of production of the aluminum alloy substrate was evaluated from the flatness thereof by observing the cut surface of the aluminum alloy substrate with a differential interference optical microscope at a magnification of 1,000 times. It should be noted that a case where the flatness was excellent was evaluated as A (excellent). A case where there was no problem in practical use although slight scratches were observed was evaluated as B (good). A case where a number of scratches were observed and many unusable parts were generated was evaluated as C (unacceptable). In this way, the evaluation was made.

The results are shown in Table 2 below.

Further, the surface of the cutting tool after processing was visually observed. As a result, those having large wear on the cutting tool are described in Table 2 as “large wear on cutting tool”.

### (Average Particle Diameter of Si Particles)

The cross section of the alloy structure of the aluminum alloy substrate was observed, and the longest diameter of Si particles and the distribution density of particles having the longest diameter of 0.5 μm or more were measured. Then, the average particle diameter was calculated from the measured distribution density of particles having the longest diameter of 0.5 μm or more.

More specifically, an aluminum alloy substrate was cut into 10 mm squares and embedded in a resin to prepare a sample. At this time, Demotec 20 (manufactured by Bodson Quality Control) (mixed at a ratio of powder:liquid=2:1 (mass ratio), room temperature-curing type) was used as the embedding resin. Next, the sample was subjected to wet polishing to expose the cross section in a horizontal direction with respect to the rolling direction, and then the sample was further etched. For etching, the sample was etched by immersing the sample in a 2.3% by mass hydrofluoric acid aqueous solution at room temperature for 30 seconds, taking it out, and then washing it with running water for 1 minute.

A backscattered electron image of the alloy structure of the sample after etching was taken using JSM-7000F (manufactured by JEOL Ltd.) of FE-SEM. At this time, the sample was conductively treated by carbon deposition in advance. With respect to this sample, the magnification was set to 2,000 times, and a backscattered electron image was taken. From this backscattered electron image having a visual field area of 2,774 μm², binarization processing was performed using WinROOF (Ver. 6.5), and the longest diameter of the Si particles and the distribution density of the particles having the longest diameter of 0.5 μm or more were measured. More specifically, according to a discriminant analysis method, the threshold was set to 200 to 255 (135 to 255 when the binarization was not successful), and binarization processing was performed. A hole filling process and a process of removing particles having a particle diameter of 0.5 μm or less were performed on the obtained image, and the distribution density of the longest diameter of the Si particles having the longest diameter of 0.5 μm or more was measured.

### (Plating Characteristic)

The aluminum alloy substrate was immersed in a NiP-based plating solution and a Ni₈₈P₁₂ film was formed as the NiP-based plating film on the surface of the aluminum alloy substrate by using the electroless plating method. Subsequently, the aluminum alloy substrate was heated at 300° C. for 3 minutes to produce an aluminum alloy substrate with a NiP-based plating film. The conditions for forming the NiP-based plating film were the same as those for the production of the substrate for a magnetic recording medium.

The surface of the NiP-based plating film of the aluminum alloy substrate attached with the NiP-based plating film was observed with a differential interference optical microscope at a magnification of 1,000 times, and the plating characteristics were evaluated from the flatness and the presence or absence of fine holes.

It should be noted that the case where the plating characteristics were particularly excellent was evaluated as A (excellent), the case where the plating characteristics were excellent was evaluated as B (good), the case where it was possible to use the substrate was evaluated as C (acceptable), and the case where the characteristics were inferior was evaluated as D (unacceptable). The results are shown in Table 2 below.

### (Young's Modulus E, Density ρ, Ratio E/ρ)

The Young's modulus of the substrate for a magnetic recording medium was measured at room temperature according to Japanese Industrial Standard JIS Z 2280-1993. It should be noted that the Young's modulus was measured by cutting out the substrate for a magnetic recording medium into a rectangular shape having a length of 50 mm, a width of 10 mm and a thickness of 0.8 mm, and using this as a test piece.

The density of the substrate for a magnetic recording medium was obtained using the literature values of the densities of constituent elements.

Then, the ratio E/ρ of the Young's modulus E to the density ρ was calculated. The results are shown in Table 2 below.

### (Fluttering Characteristic)

The fluttering was evaluated by measuring NRRO values. For the NRRO value, the substrate for a magnetic recording medium was rotated at 10,000 rpm for 1 minute, and the range of displacement due to the fluttering occurring at the outermost peripheral surface of the substrate for a magnetic recording medium was measured using a He—Ne laser displacement meter, and the maximum value of the obtained displacement range was taken as the NRRO value.

Those in which the NRRO value was 3.2 μm or less were evaluated as A (excellent), those in which the NRRO value was more than 3.2 μm and 3.4 μm or less were evaluated as B (good), those in which the NRRO value was more than 3.4 μm and 3.6 μm or less were evaluated as C (acceptable), and those in which the NRRO value exceeded 3.6 μm were evaluated as D (unacceptable). The results are shown in Table 2 below.

TABLE 1

| | Composition of aluminum alloy substrate (% by mass) | | | | | | | | | | | | | |
|---|---|---|---|---|---|---|---|---|---|---|---|---|---|---|
| | Si | Cu | Sr | Z [symbol] | Cr | Ti | Ni | Mn | Z [symbol] | Mg | B | P | Fe | Al |
| Ex. 1 | 11.0 | 2.0 | 0.02 | — | — | — | — | — | — | <0.05 | <0.001 | <0.001 | <0.01 | Balance |
| Ex. 2 | 9.5 | 2.0 | 0.02 | — | — | — | — | — | — | <0.05 | <0.001 | <0.001 | <0.01 | Balance |
| Ex. 3 | 13.0 | 2.0 | 0.02 | — | — | — | — | — | — | <0.05 | <0.001 | <0.001 | <0.01 | Balance |
| Ex. 4 | 11.0 | 0.5 | 0.02 | — | — | — | — | — | — | <0.05 | <0.001 | <0.001 | <0.01 | Balance |
| Ex. 5 | 11.0 | 3.0 | 0.02 | — | — | — | — | — | — | <0.05 | <0.001 | <0.001 | <0.01 | Balance |
| Ex. 6 | 11.0 | 2.0 | 0.005 | — | — | — | — | — | — | <0.05 | <0.001 | <0.001 | <0.01 | Balance |
| Ex. 7 | 11.0 | 2.0 | 0.1 | — | — | — | — | — | — | <0.05 | <0.001 | <0.001 | <0.01 | Balance |
| Ex. 8 | 11.0 | 2.0 | 0.02 | 0.35 | 0.1 | 0.1 | — | 0.1 | 0.05 | <0.05 | <0.001 | <0.001 | <0.01 | Balance |
| Ex. 9 | 11.0 | 2.0 | 0.02 | 0.01 | — | — | — | — | — | <0.05 | <0.001 | <0.001 | <0.01 | Balance |
| Ex. 10 | 11.0 | 2.0 | 0.02 | 0.45 | — | — | — | — | — | <0.05 | <0.001 | <0.001 | <0.01 | Balance |
| Ex. 11 | 11.0 | 2.0 | 0.02 | — | 0.005 | — | — | — | — | <0.05 | <0.001 | <0.001 | <0.01 | Balance |
| Ex. 12 | 11.0 | 2.0 | 0.02 | — | 0.3 | — | — | — | — | <0.05 | <0.001 | <0.001 | <0.01 | Balance |
| Ex. 13 | 11.0 | 2.0 | 0.02 | — | — | 0.005 | — | — | — | <0.05 | <0.001 | <0.001 | <0.01 | Balance |
| Ex. 14 | 11.0 | 2.0 | 0.02 | — | — | 0.3 | — | — | — | <0.05 | <0.001 | <0.001 | <0.01 | Balance |
| Ex. 15 | 11.0 | 2.0 | 0.02 | — | — | — | 0.005 | — | — | <0.05 | <0.001 | <0.001 | <0.01 | Balance |
| Ex. 16 | 11.0 | 2.0 | 0.02 | — | — | — | 0.3 | — | — | <0.05 | <0.001 | <0.001 | <0.01 | Balance |
| Ex. 17 | 11.0 | 2.0 | 0.02 | — | 0.3 | 0.3 | 0.3 | — | — | <0.05 | <0.001 | <0.001 | <0.01 | Balance |
| Ex. 18 | 11.0 | 2.0 | 0.02 | — | — | — | — | 0.05 | — | <0.05 | <0.001 | <0.001 | <0.01 | Balance |
| Ex. 19 | 11.0 | 2.0 | 0.02 | — | — | — | — | 0.4 | — | <0.05 | <0.001 | <0.001 | <0.01 | Balance |
| Ex. 20 | 11.0 | 2.0 | 0.02 | — | — | — | — | — | 0.03 | <0.05 | <0.001 | <0.001 | <0.01 | Balance |
| Ex. 21 | 11.0 | 2.0 | 0.02 | — | — | — | — | — | 0.3 | <0.05 | <0.001 | <0.001 | <0.01 | Balance |
| Ex. 22 | 11.0 | 2.0 | 0.02 | — | — | — | — | — | — | 0.05 | <0.001 | <0.001 | <0.01 | Balance |
| Ex. 23 | 11.0 | 2.0 | 0.02 | — | — | — | — | — | — | <0.05 | 0.001 | <0.001 | <0.01 | Balance |
| Ex. 24 | 11.0 | 2.0 | 0.02 | — | — | — | — | — | — | <0.05 | <0.001 | 0.001 | <0.01 | Balance |
| Comp. Ex. 1 | 9.0 | 2.0 | 0.02 | — | — | — | — | — | — | <0.05 | <0.001 | <0.001 | <0.01 | Balance |
| Comp. Ex. 2 | 14.0 | 2.0 | 0.02 | — | — | — | — | — | — | <0.05 | <0.001 | <0.001 | <0.01 | Balance |
| Comp. Ex. 3 | 11.0 | 0.4 | 0.02 | — | — | — | — | — | — | <0.05 | <0.001 | <0.001 | <0.01 | Balance |
| Comp. Ex. 4 | 11.0 | 3.2 | 0.02 | — | — | — | — | — | — | <0.05 | <0.001 | <0.001 | <0.01 | Balance |
| Comp. Ex. 5 | 11.0 | 2.0 | 0.004 | — | — | — | — | — | — | <0.05 | <0.001 | <0.001 | <0.01 | Balance |
| Comp. Ex. 6 | 11.0 | 2.0 | 0.12 | — | — | — | — | — | — | <0.05 | <0.001 | <0.001 | <0.01 | Balance |
| Comp. Ex. 7 | 11.0 | 2.0 | 0.02 | — | — | — | — | — | — | <0.05 | <0.001 | <0.001 | 0.01 | Balance |

[symbol]

indicates data missing or illegible when filed

TABLE 2

| | | | Average particle diameter of Si | | | | | |
|---|---|---|---|---|---|---|---|---|
| | | | particles having the longest | | | | | |
| | | Workability | diameter of 0.5 or more | Plating | Young modulus | Density | | |
| | Castability | (machinability) | (μm) | characteristic | (GPa) | (g/cm³) | E/ρ | Fluttering |
| Ex. 1 | B | B | 1.8 | B | 82 | 2.78 | 29.5 | B |
| Ex. 2 | B | B | 1.7 | B | 81 | 2.79 | 29.1 | C |
| Ex. 3 | B | B | 2.0 | C | 86 | 2.78 | 31.0 | A |
| Ex. 4 | B | B | 1.8 | B | 79 | 2.69 | 29.4 | C |
| Ex. 5 | B | B | 1.8 | B | 83 | 2.84 | 29.2 | B |
| Ex. 6 | B | B | 1.8 | B | 82 | 2.78 | 29.5 | B |
| Ex. 7 | B | B | 1.8 | B | 82 | 2.78 | 29.5 | B |
| Ex. 8 | A | A | 1.8 | A | 84 | 2.81 | 29.9 | A |
| Ex. 9 | B | A | 1.8 | A | 82 | 2.78 | 29.5 | B |
| Ex. 10 | B | A | 1.8 | A | 82 | 2.80 | 29.3 | B |
| Ex. 11 | A | B | 1.8 | B | 82 | 2.78 | 29.5 | B |
| Ex. 12 | A | B | 1.8 | B | 82 | 2.80 | 29.3 | B |
| Ex. 13 | A | B | 1.8 | B | 82 | 2.78 | 29.5 | B |
| Ex. 14 | A | B | 1.8 | B | 82 | 2.79 | 29.4 | B |
| Ex. 15 | A | B | 1.8 | B | 82 | 2.78 | 29.5 | B |
| Ex. 16 | A | B | 1.8 | B | 83 | 2.80 | 29.6 | B |
| Ex. 17 | A | B | 1.8 | B | 82 | 2.82 | 29.1 | B |
| Ex. 18 | B | A | 1.8 | B | 82 | 2.79 | 29.4 | B |
| Ex. 19 | B | A | 1.8 | B | 82 | 2.80 | 29.3 | B |
| Ex. 20 | B | B | 1.8 | A | 82 | 2.78 | 29.5 | B |
| Ex. 21 | B | B | 1.8 | A | 82 | 2.79 | 29.3 | B |
| Ex. 22 | C | B | 1.8 | B | 82 | 2.78 | 29.5 | B |
| Ex. 23 | C | B | 2.0 | B | 82 | 2.78 | 29.5 | B |
| Ex. 24 | B | B | 2.0 | C | 82 | 2.78 | 29.5 | B |
| Comp. Ex. 1 | B | C | 1.7 | B | 77 | 2.79 | 27.6 | D |
| Comp. Ex. 2 | B | Large wear on | 3.0 | D | 86 | 2.77 | 31.0 | B |
| | | cutting tool | | | | | | |
| Comp. Ex. 3 | B | B | 1.8 | B | 77 | 2.68 | 28.7 | D |
| Comp. Ex. 4 | B | B | 1.8 | B | 81 | 2.86 | 28.3 | D |
| Comp. Ex. 5 | B | Large wear on | 5.0 | D | 82 | 2.78 | 29.5 | B |
| | | cutting tool | | | | | | |
| Comp. Ex. 6 | C | Large wear on | 11.0 | D | 81 | 2.78 | 29.1 | B |
| | | cutting tool | | | | | | |
| Comp. Ex. 7 | B | C | 1.8 | D | 81 | 2.78 | 29.1 | B |

In Comparative Example 1, the workability at the time of manufacturing the aluminum alloy substrate was deteriorated, the Young's modulus of the substrate for a magnetic recording medium was low, and the fluttering deteriorated.

It is thought that this is because the content of Si is small.

It should be noted that in Comparative Example 1, the average particle diameter of the Si particles of the aluminum alloy substrate is 2 μm or less, and the ratio E/ρ is 29 or less as shown in Table 2.

On the other hand, in Comparative Example 2, the average particle diameter of the Si particles of the aluminum alloy substrate was as large as 3.0 μm as shown in Table 2, and the wear on the cutting tool during processing (cutting) became large. In addition, the plating characteristics of the obtained substrate for a magnetic recording medium were lowered. It is considered that this is because the content of Si exceeded a predetermined range.

In Comparative Example 3, the Young's modulus E of the substrate for a magnetic recording medium was low and the fluttering deteriorated. It is presumed that this is because the content of Cu is smaller than the range of the present invention. In addition, since the content of Cu is smaller than the range of the present invention, it is also presumed that this is due to a decrease in the Young's modulus.

It should be noted that in Comparative Example 3, the average particle diameter of the Si particles of the aluminum alloy substrate is 2 μm or less, and the ratio E/ρ is 29 or less as shown in Table 2.

In Comparative Example 4, the density ρ of the substrate for a magnetic recording medium was high and the fluttering was deteriorated. It is presumed that this is because the content of Cu exceeded the range of the present invention. Further, since the content of Cu exceeded the range of the present invention, it is also presumed that this is due to the density ρ of the substrate for a magnetic recording medium becoming too high.

It should be noted that in Comparative Example 4, the average particle diameter of the Si particles of the aluminum alloy substrate is 2 μm or less, and the ratio E/ρ is 29 or less as shown in Table 2.

In Comparative Example 5, the average particle diameter of the Si particles of the substrate for a magnetic recording medium was as large as 5.0 μm as shown in Table 2, and the wear on the cutting tool during processing (cutting) became large. In addition, the plating characteristics of the substrate for a magnetic recording medium deteriorated. It is thought that this is because the Si particles became coarse due to the small content of Sr.

In Comparative Example 6, the average particle diameter of the Si particles of the aluminum alloy substrate was as large as 11.0 μm as shown in Table 2, and the wear on the cutting tool during processing (cutting) became large. In addition, the plating characteristics of the substrate for a magnetic recording medium deteriorated. It is thought that this is because SrAl₄ became a nucleus and Si particles of primary crystals became coarse due to the large content of Sr.

In Comparative Example 7, a large number of scratches were generated during processing in the production of the aluminum alloy substrate, and the workability deteriorated. In addition, the plating characteristics of the substrate for a magnetic recording medium deteriorated. It is considered that this is because coarse crystallized products of an Al—Si—Fe compound were generated due to the Fe content exceeding the range of the present invention.

With respect to these comparative examples, the castability and workability were excellent in Examples 1 to 24, and in the substrate for a magnetic recording medium thereof, the plating characteristics improved while suppressing the level of fluttering. In Examples 1 to 24, the aluminum alloy substrate contains Si, Cu, Sr and Fe in specific ranges. In Examples 1 to 24, the aluminum alloy substrate contains Si, Cu and Fe in specific ranges, and the average particle diameters of the Si particles are included in specific ranges. In Examples 1 to 24, the substrate for a magnetic recording medium has a ratio E/ρ of 29 or more.

Further, in Example 8 in which the respective elements of Zn, Cr, Ti, Mn, Zr, Mg, B and P are included in predetermined ranges, the castability and workability are further improved, the plating characteristics of the substrate for a magnetic recording medium were further improved, and the fluttering was further suppressed.

In addition, in Examples 9 to 10 containing Zn in a predetermined range, the workability was further improved, and the fluttering was further suppressed in the substrate for a magnetic recording medium.

Further, in Examples 11 to 17 containing Cr, Ti, and Ni in predetermined ranges, the castability and workability were further improved.

In addition, in Examples 18 to 19 containing Mn in a predetermined range, the workability was further improved.

Further, in Examples 20 to 21 containing Zr in a predetermined range, the plating characteristics of the substrate for a magnetic recording medium were further improved and the fluttering was further suppressed.

In addition, in Example 22 in which the content of Mg was slightly higher, the castability slightly decreased.

In addition, in Example 23 in which the content of B was slightly large, the average particle diameter of Si became large.

Further, in Example 24 in which the content of P was slightly higher, the workability and the plating characteristics slightly decreased.

As described above, according to the present invention, it is possible to provide a substrate for a magnetic recording medium with improved plating characteristics while suppressing the level of fluttering, which is a thin shaped substrate capable of being accommodated in larger numbers as compared with the conventional case in a drive case of a standardized hard disk drive; and an aluminum alloy substrate for a magnetic recording medium which can be advantageously used as a base material for the substrate for a magnetic recording medium.

### DESCRIPTION OF THE REFERENCE SYMBOLS

10: Substrate for magnetic recording medium
11: Aluminum alloy substrate
12: NiP-based plating film
20: Grinding machine
21, 22: Surface plate
23: Polishing pad
30: Magnetic recording medium
31: Magnetic layer
32: Protective layer
33: Lubricant layer
40: Hard disk drive
41: Medium driving unit
42: Magnetic head
43: Head moving portion
44: Recording/reproducing signal processing unit
W: Substrate

1. An aluminum alloy substrate for a magnetic recording medium, the substrate comprising:
Si in a range of 9.5% by mass or more and 13.0% by mass or less;
Cu in a range of 0.5% by mass or more and 3.0% by mass or less; and
Sr in a range of 0.005% by mass or more and 0.1% by mass or less,
wherein a content of Fe is less than 0.01% by mass;
the balance is Al; and
the substrate has a diameter in a range of 53 mm or more and 97 mm or less and a thickness in a range of 0.4 mm or more and 0.9 mm or less.

2. The aluminum alloy substrate for a magnetic recording medium according to claim 1, further comprising Zn in a range of 0.01% by mass or more and 0.4% by mass or less.

3. The aluminum alloy substrate for a magnetic recording medium according to claim 1, further comprising at least one or more types of metal elements selected from the group consisting of Cr, Ti and Ni in a range of 0.005% by mass or more and 1.0% by mass or less in total.

4. The aluminum alloy substrate for a magnetic recording medium according to claim 1, further comprising Mn in a range of 0.05% by mass or more and 0.4% by mass or less.

5. The aluminum alloy substrate for a magnetic recording medium according to claim 1, further comprising Zr in a range of 0.03% by mass or more and 0.3% by mass or less.

6. The aluminum alloy substrate for a magnetic recording medium according to claim 1, wherein a content of Mg is less than 0.05% by mass.

7. The aluminum alloy substrate for a magnetic recording medium according to claim 1, wherein a content of B is less than 0.001% by mass.

8. The aluminum alloy substrate for a magnetic recording medium according to claim 1, wherein a content of P is less than 0.001% by mass.

9. The aluminum alloy substrate for a magnetic recording medium according to claim 1,
wherein at least a part of said Si is present as Si particles, and
an average particle diameter of particles having a longest diameter of 0.5 μm or more among said Si particles is 2 μm or less.

10. A substrate for a magnetic recording medium, the substrate comprising:
the aluminum alloy substrate according to claim 1; and
a NiP-based plating film formed on at least one surface of said aluminum alloy substrate.

11. A magnetic recording medium comprising:
the substrate for a magnetic recording medium according to claim 9; and
a magnetic layer provided on a surface of said substrate for a magnetic recording medium on a side where said NiP-based plating film is formed.

12. A hard disk drive comprising the magnetic recording medium according to claim 11.

13. An aluminum alloy substrate for a magnetic recording medium, the substrate comprising:
Si in a range of 9.5% by mass or more and 13.0% by mass or less; and
Cu in a range of 0.5% by mass or more and 3.0% by mass or less,
wherein a content of Fe is less than 0.01% by mass;
the balance is Al;
at least a part of said Si is present as Si particles, and
an average particle diameter of particles having a longest diameter of 0.5 μm or more among said Si particles is 2 μm or less, and
the substrate has a diameter in a range of 53 mm or more and 97 mm or less and a thickness in a range of 0.4 mm or more and 0.9 mm or less.

14. The aluminum alloy substrate for a magnetic recording medium according to claim 13, further comprising Sr in a range of 0.005% by mass or more and 0.1% by mass or less.

15. A substrate for a magnetic recording medium, the substrate comprising:
the aluminum alloy substrate according to claim 13; and
a NiP-based plating film formed on at least one surface of said aluminum alloy substrate.

16. A magnetic recording medium comprising:
the substrate for a magnetic recording medium according to claim 15; and
a magnetic layer provided on a surface of said substrate for a magnetic recording medium on a side where said NiP-based plating film is formed.

17. A hard disk drive comprising the magnetic recording medium according to claim 16.

18. A substrate for a magnetic recording medium, the substrate comprising:
an aluminum alloy substrate; and
a NiP-based plating film formed on at least one surface of said aluminum alloy substrate,
wherein a ratio E/ρ of a Young's modulus E expressed in a unit of GPa to a density ρ expressed in a unit of g/cm³, of said substrate, is 29 or more; and
said aluminum alloy substrate comprises Si in a range of 9.5% by mass or more and 13.0% by mass or less and Cu in a range of 0.5% by mass or more and 3.0% by mass or less, and in which a content of Fe is less than 0.01% by mass, the balance is Al,
the substrate has a diameter in a range of 53 mm or more and 97 mm or less and a thickness in a range of 0.4 mm or more and 0.9 mm or less, and
has at least one of characteristics (i) and (ii):
(i) Sr is contained in said substrate in a range of 0.005% by mass or more and 0.1% by mass or less; and
(ii) at least a part of said Si is present as Si particles, and an average particle diameter of particles having a longest diameter of 0.5 μm or more among said Si particles is 2 μm or less.

19. A magnetic recording medium comprising: the substrate for a magnetic recording medium according to claim 18; and a magnetic layer provided on a surface of said substrate for a magnetic recording medium on a side where said NiP-based plating film is formed.

20. A hard disk drive comprising the magnetic recording medium according to claim 19.
